(19) United States
(12) Patent Application Publication
(10) Pub. No.: US 2013/0084721 A1
(43) Pub. Date: Apr. 4, 2013

(54) Pick and Place Cap For An Electrical Connector

(71) Applicant: Chin Hua Lim, Singapore (SG)

(72) Inventor: Chin Hua Lim, Singapore (SG)

(73) Assignee: 3M INNOVATIVE PROPERTIES COMPANY, ST. PAUL, MN (US)

(21) Appl. No.: 13/642,875

(22) PCT Filed: May 6, 2011
(86) PCT No.: PCT/US11/35441

§ 371 Date: Oct. 23, 2012

(30) Foreign Application Priority Data
May 25, 2010 (SG) 201003653-1

(51) Int. Cl. H01R 43/20

(52) U.S. Cl. CPC H01R 43/20
USPC 439/135; 29/428

(57) ABSTRACT

A method includes providing an electrical connector (102) for a memory card, placing a pick and place cap (104) onto the connector (102), including engaging a set of jaws (112, 114) over a row of connector contacts (106) whilst substantially preventing deformation of the contacts (106), picking up the connector (102) via the cap (104), and placing the connector (102) on a circuit board. Also included are a pick and place cap (104) for an electrical connector (102) and an apparatus (100).

### FIELD

The invention relates to a method, an electronic device, a pick and place cap for an electrical connector and an apparatus.

### BACKGROUND

During the manufacture of electronic devices, some components are picked up from a magazine or tape & reel and placed on a circuit board to be soldered. During the pick and place operation the vacuum head of the pick and pack apparatus may apply suction to a surface of the component. However, some components do not have a suitable surface for the vacuum head.

One alternative is to temporarily attach a cap to the component, so that the vacuum head attaches to the cap during the pick and place operation. The cap can then be removed after placement or soldering.

### SUMMARY

In general terms the invention relates to a cap with multiple pick and place surfaces and/or preventing damage to the connector contacts during insertion/removal. This may have the advantage that the cap can be flexibly used for a number of different pick and place configurations and/or that the reliability of the electronic device may be improved.

In a first specific expression of the invention there is provided a method comprising: providing an electrical connector for a memory card, placing a pick and place cap onto the connector, including engaging a set of jaws over a row of connector contacts whilst substantially preventing deformation of the contacts, picking up the connector via the cap, and placing the connector on a circuit board.

In a second specific expression of the invention there is provided an electronic device manufactured according to the method in the first specific expression.

In a third specific expression of the invention there is provided a pick and place cap for an electrical connector comprising: a set of jaws to fit over a row of connector contacts, a first surface, and a second surface opposed to the first surface, wherein the first surface and the second surface are configured for attachment to a pick and place apparatus.

In a forth specific expression of the invention there is provided apparatus comprising: an electrical connector for a memory card, and a cap according to the third specific expression, the cap configured for engagement with the connector.

### BRIEF DESCRIPTION OF THE DRAWINGS

In order that the invention may be fully understood and readily put into practical effect there shall now be described by way of non-limitative example only, an example embodiment described below with reference to the accompanying illustrative drawings in which:

FIG. 1 is a cross section of an exemplary embodiment of a pick and place cap according to an aspect of the present invention attached to an electrical connector,

FIG. 2 is a perspective view of the cross section in FIG. 1,

FIG. 3 is a perspective view of the cap and connector of FIG. 1 about to be engaged,

FIG. 4 is a cross section of FIG. 3,

FIG. 5 is a perspective view of the cap and connector of FIG. 1 engaged,

FIG. 6 is a cross section of FIG. 5,

FIG. 7 is a perspective view of the top of the cap of FIG. 1,

FIG. 8 is a perspective view of the bottom of the cap of FIG. 1,

FIG. 9 is a left side view of the cap of FIG. 1, and

FIG. 10 is a flow chart of an exemplary embodiment of a method of manufacturing an electronic device.

### DETAILED DESCRIPTION

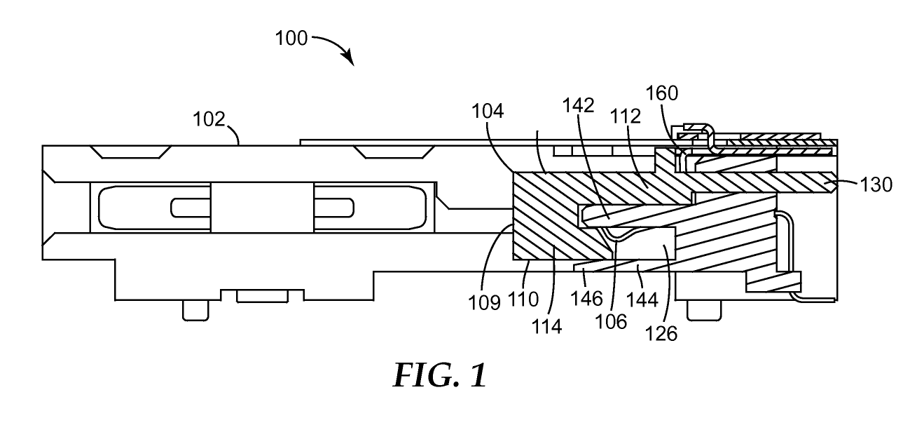

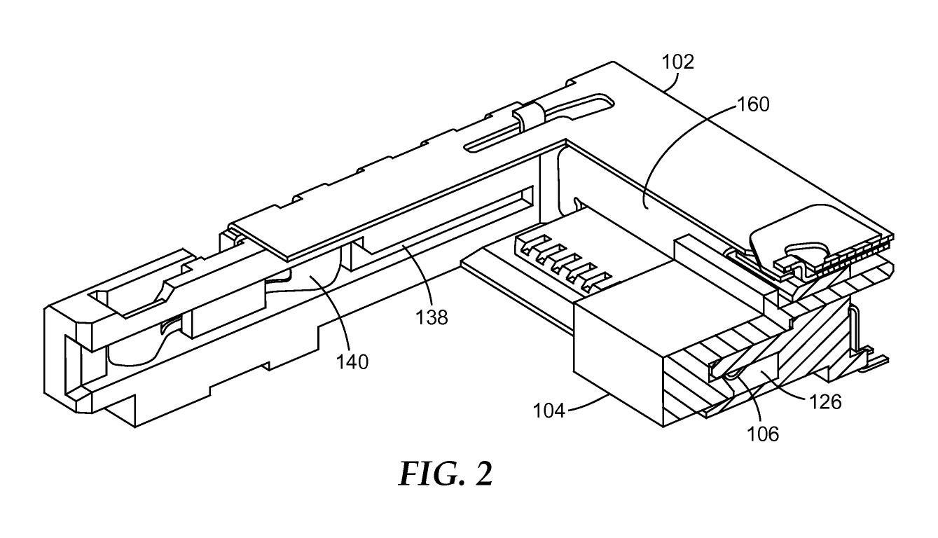

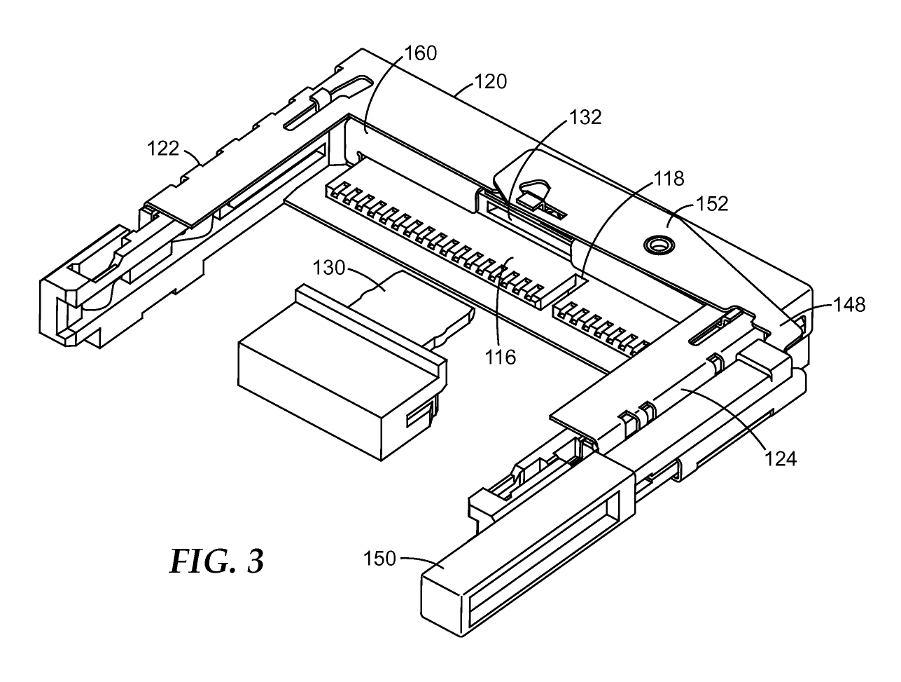

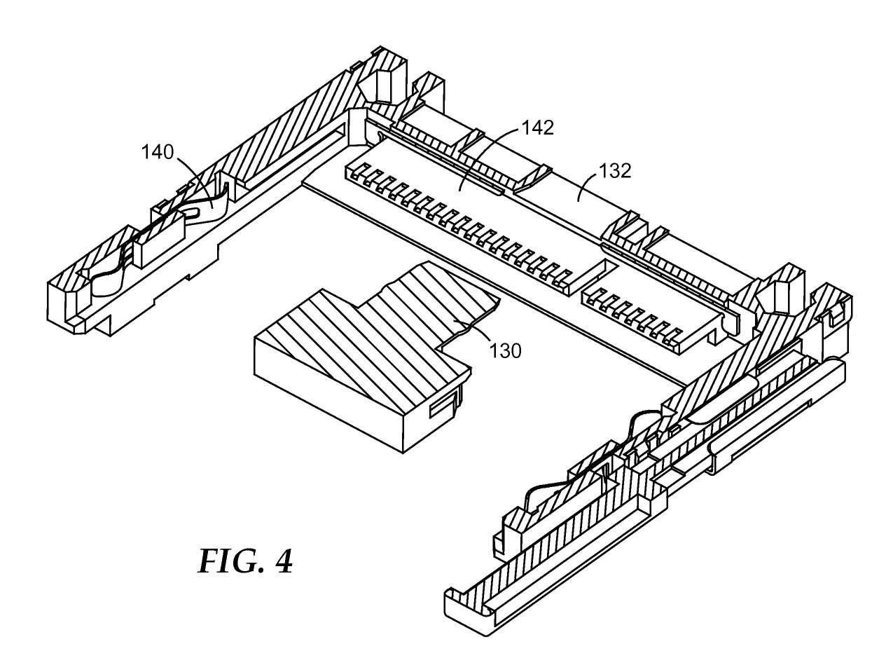

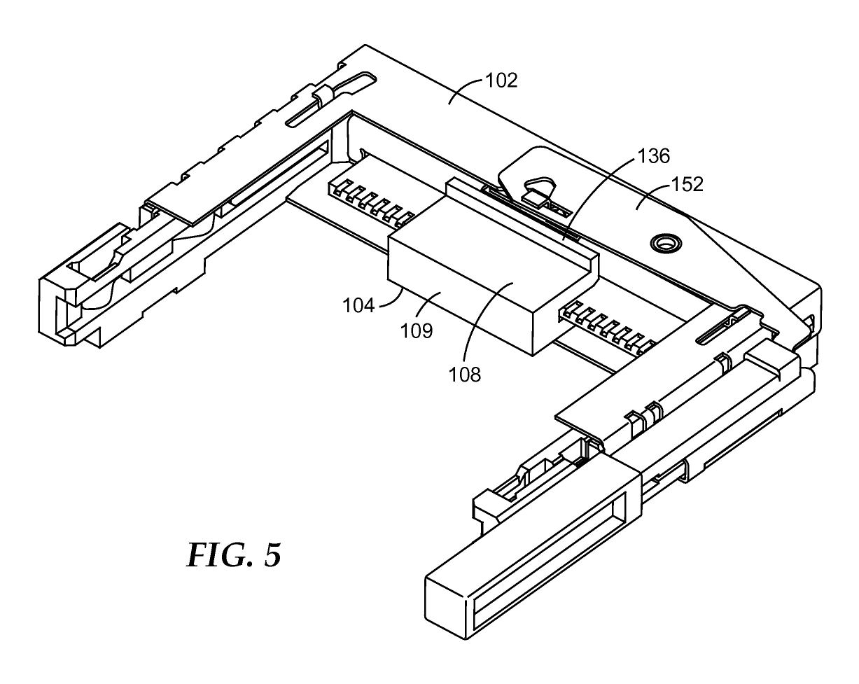

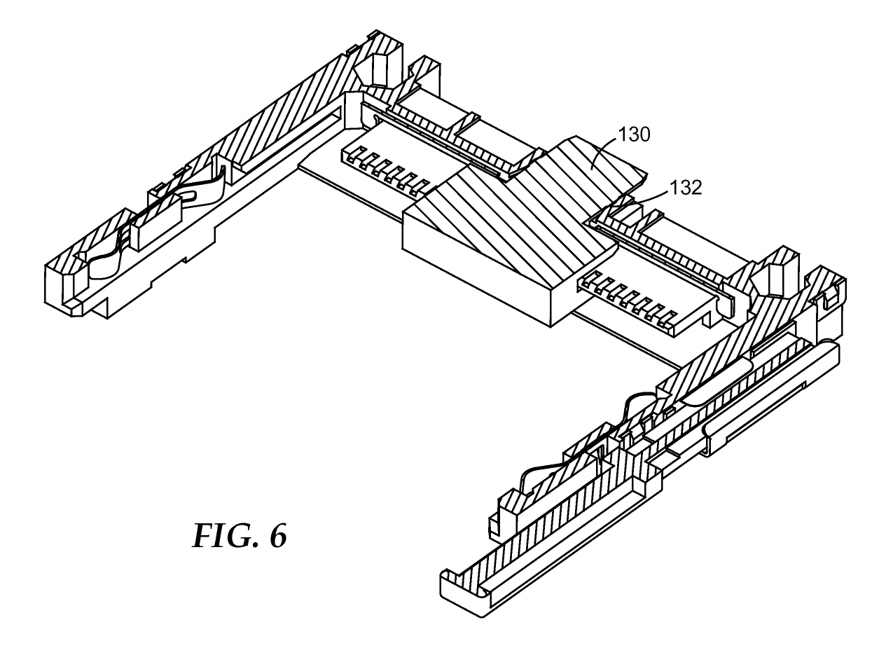

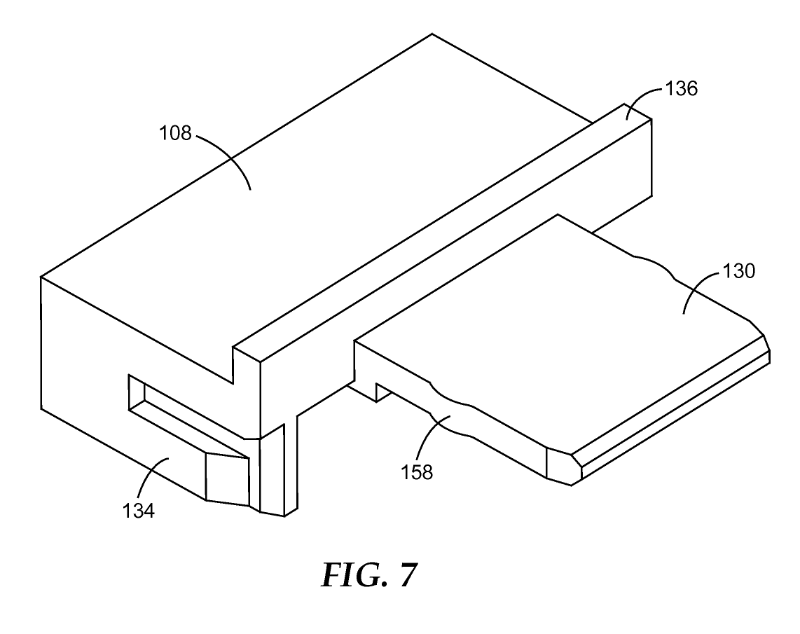

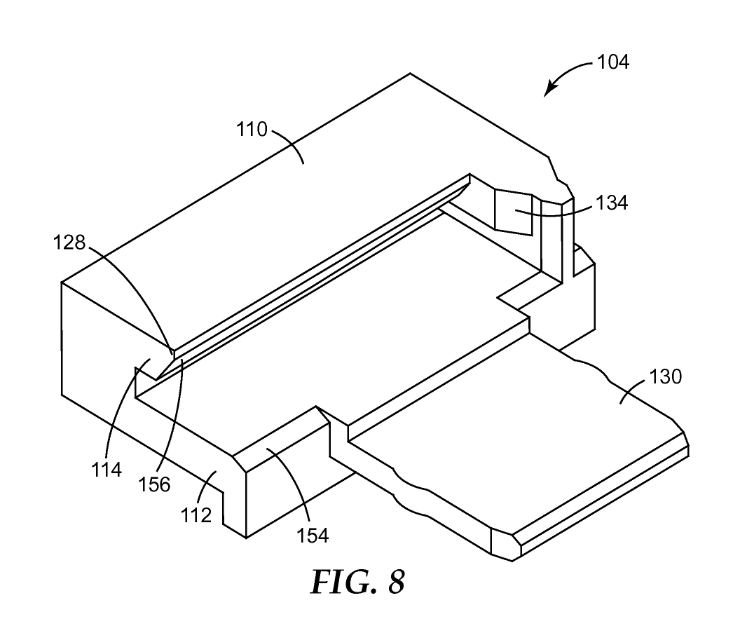

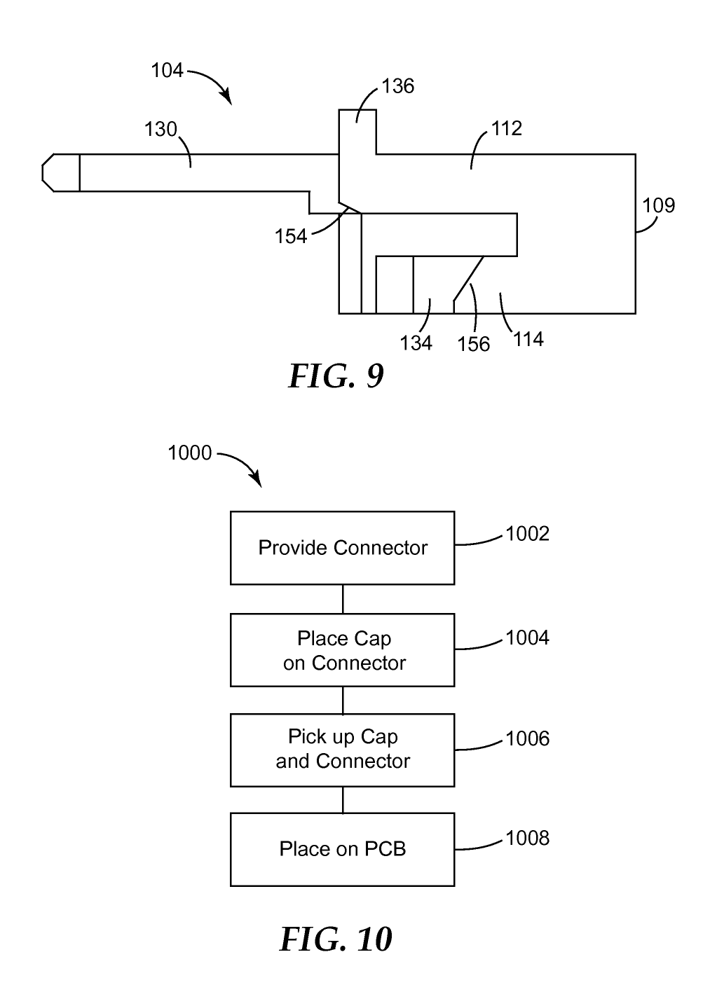

FIGS. 1 to 9 show an exemplary embodiment of an apparatus 100 for manufacturing an electronic device. In particular a connector 102 according to the CFast industry standard for a memory card is picked up and placed on a circuit board by a pick and place machine, and mechanically and electrically connected to the circuit board. Because the connector 102 does not have any surfaces suitable for the vacuum head of the pick and place machine, a cap 104 is temporarily attached to the connector 102 during the pick and place operation. After the pick and place operation the cap 104 is ejected from the connector 102.

The connector 102 will now be described with reference to FIGS. 1 to 6. The connector 102 has a main elongate section 120, and two side elongate sections 122,124. Each side section 122,124 extends substantially perpendicularly from a respective end of the main section 120. The side sections 122,124 and main section 120 respectively form an approximate “U” shape.

Each side section 122,124 includes a lengthwise slot 138 to guide each respective side edge of the memory card during insertion. The slot 138 includes a latch 140 to firmly engage the memory card so that is cannot be accidently dislodged when in use.

There are at least the following 2 connector configurations. In a first configuration, called an elevated height type, the main section 120 includes a lengthwise slot 126 to house the front edge of the memory card. The upper wall of the slot 126 is a slotted tongue 142, which extends most of the length of the main section 120. The bottom wall of the slot 126 is a tapered flange 144. The tapered flange 144 runs the full length of the main section 120 and the taper 146 is on the upper side of its edge, to ease the insertion of the cap 104. The tapered flange 144 is primarily to support the insertion of memory card and helps to hold the card in place. The tapered flange 144 is slightly wider than the slotted tongue 142. In a second configuration, called a standard height type, which is lower in height, the slot, and the taper flange are not present, but the slotted tongue 142 is still present.

Each slot in the slotted tongue 142 may house a contact 106. Each contact may be an active contact, in that each contact 106 protrudes slightly into the slot 126 and deflects when mated with the contacts on the memory card. There are 24 contact slots and depending on the application there may be up to 24 contacts.

In a slightly off centre location, substantially between the 7th and 8^{th} contact slot, there is a locating slot 118 in the slotted tongue 142.

Above the slotted tongue 142 is a locating aperture 132.

On the upper surface of the connector 102 is an ejector system 148. This is normally used to eject the memory card, but can also be used to eject the cap 104. There is a push button 150 substantially on the end of the right side section 124, which actuates a pivoting flap 152 on top of the main section 120. When the button 150 is pressed the pivoting flap 152 pushes against dual push plate 160 which in turn ejects the memory card or cap.

The connector 102 is generally constructed of moulded plastics. The ejector 148 and sprung flap 140 may include metal portions.

The cap 104 will now be described with reference to FIGS. 1 to 9. The cap 104 is integrally constructed of moulded plastics. The cap 104 is generally “T” shaped in plan view, with three main surfaces; a top surface 108, an end surface 109 and a bottom surface 110. Each of these three main surfaces may be substantially smooth and of appropriate dimensions to allow the vacuum head to reliably attach to the surface. The top surface 108 and bottom surface 110 are substantially parallel to each other and the end surface is substantially perpendicular to both.

Underneath the top surface 108 is a top jaw 112. The top jaw 112 runs the length of the cap 104 and includes a taper 154 at its front edge for ease of insertion to the connector 102. The top jaw 112 is the same width as the slotted tongue 142. Above the bottom surface 110 is a bottom jaw 114. The bottom jaw 114 runs the length of the cap 104 and includes a taper 156 at its front edge for ease of insertion to the connector 102.

The width of the bottom jaw 114 is less than the top jaw and a tip 128 and the taper 156 of the bottom jaw 114 are substantially proximate, but not touching the contacts 106, when the cap 104 is engaged. In order to increase the reliability of the electronic device as long as the cap 104 is inserted in the correct orientation the cap 104 is prevented from contacting the contacts 106 during insertion or removal. In the unlikely event the cap 104 is inserted in the incorrect orientation, the deflection of the contacts 106 is substantially limited. The cap is designed so that it is unable to fully inserted into the same depth when inserted in the wrong orientation. The thickness of the bottom jaw 114 is the same as the memory card. The top jaw 112 may be the same thickness as the bottom jaw 114.

To improve the reliability of the pick and place operation, the cap 104 may be placed as close as possible to the centre of gravity of the connector 102. The most convenient location is substantially the middle 116 of the main section 120 on an inner face. To assist with the horizontal locating of the cap 104 during insertion, a locating flange 134 on the cap 104 is designed to slide into the locating slot 118. The locating flange 134 has a tapered front edge to assist insertion. The locating flange 134 is generally “T” shaped in cross section, with the bar of the T pressing firm on the underside of the slotted tongue 142 on either side of the locating slot 118 when engaged. The locating flange 134 extends substantially from underneath the top jaw 112, near the right hand end.

A tongue 130 extends substantially from the front edge of the top jaw 112. The tongue 130 is inserted into the locating aperture 132. The engagement of the tongue 130 with locating aperture 132 assists with the vertical locating of the cap 104 during insertion. The locating aperture 132 also locks the tongue 130 in place once engaged with the connector 102. The locking is provided by bumps 158 substantially on the side of the tongue 130 which resiliently engage the locating aperture 132. The tongue 130 has a tapered front edge to assist insertion.

An ejector tab 136 extends substantially vertically from the front edge of the top surface 108. The tab 136 is high enough to allow the push plate 160 or an operator to eject the cap 104, but does not substantially protrude above the top of the connector 102.

The cap 104 and connector 102 may be manufactured together with the cap 104 pre inserted. Alternatively the connector 102 may be manufactured separately and may only be manually combined just prior to the pick and place of the connector 102 onto the circuit.

A method 1000 for manufacturing an electronic device will now be described with reference to FIG. 10. At 1002 an electrical connector for a memory card is provided, for example according to the CFast industry standard. At 1004 a pick and place cap is placed onto the connector. The cap includes a set of jaws which are engaged over a row of connector contacts in the connector. During insertion and removal of the cap deformation of the contacts is substantially prevented. At 1006 the connector is picked up by a pick and place apparatus via the cap. At 1008 the connector is placed on a circuit board and mechanically bonded and electrically connected to the circuit board.

Following are exemplary embodiments of a method, an electronic device, a pick and place cap, and an apparatus according to aspects of the present invention.

Embodiment 1 is a method comprising: providing an electrical connector for a memory card, placing a pick and place cap onto the connector, including engaging a set of jaws over a row of connector contacts whilst substantially preventing deformation of the contacts, picking up the connector via the cap, and placing the connector on a circuit board.

Embodiment 2 is the method of embodiment 1 wherein picking up the connector via the cap comprises picking up the cap on a first surface or on a second surface opposed to the first surface.

Embodiment 3 is the method of embodiments 1 or 2 further comprising removing the cap from the connector.

Embodiment 4 is the method of any one of the preceding embodiments further comprising locating the cap at a predetermined location.

Embodiment 5 is the method of any one of the preceding embodiments further comprising locking the cap in place on the connector.

Embodiment 6 is the method of any one of the preceding embodiments wherein providing the connector comprises providing a generally U-shaped connector.

Embodiment 7 is the method of embodiment 6 wherein the connector comprises a main elongate section and two side elongate sections each side section extending perpendicularly from a respective end of the main section.

Embodiment 8 is the method of embodiment 7 wherein the main section including a lengthwise slot, and the contacts extending into one side of the slot, the contacts configured to engage with contacts on a memory card when inserted into the connector.

Embodiment 9 is the method of embodiment 2 wherein picking up the cap comprises locating a vacuum head on the first surface or the second surface, applying suction to the first surface or the second surface, moving the cap and connector from a first location to a second location proximate the circuit board.

Embodiment 10 is the method of any one of the preceding embodiments wherein the connector is a connector according to the CFast industry standard.

Embodiment 11 is the method of embodiment 4 wherein the predetermined location is in a central portion of the connector.

Embodiment 12 is the method of any of the preceding embodiments wherein substantially preventing deformation of the contacts comprises preventing contact between the cap and the contacts during placing, removing and during engagement of the cap.

Embodiment 13 is the method of embodiment 9 wherein the vacuum head applies suction to the first surface, the second surface or to a third surface perpendicular to the first and second surfaces.

Embodiment 14 is an electronic device manufactured according to the method of any one of embodiments 1 to 13.

Embodiment 15 is a pick and place cap for an electrical connector comprising: a set of jaws to fit over a row of connector contacts, a first surface, and a second surface opposed to the first surface, wherein the first surface and the second surface are configured for attachment to a pick and place apparatus.

Embodiment 16 is the cap of embodiment 15 wherein the jaws are configured to lock the cap onto the connector and wherein the jaws are configured to substantially prevent any deformation of the contacts.

Embodiment 17 is the cap of embodiment 16 wherein the jaws comprise a first jaw and a second jaw, the first jaw configured to extend over one side of the contacts, the second jaw configured to extend to a location proximate to the contacts.

Embodiment 18 is the cap of embodiment 17 further comprising a tongue extending from the first jaw configured to resiliently engage an aperture or groove in the connector.

Embodiment 19 is the cap of embodiment 17 or 18 further comprising T shaped flange extending from the first jaw configured to engage a locating slot in the connector.

Embodiment 20 is the cap of any one of embodiments 17 to 19 further comprising an ejector tab extending from the first jaw configured to abut against the connector in an engaged position, and configured to be pressed to remove the cap from the connector.

Embodiment 21 is the cap of any one of embodiments 15 to 20 further comprising a third surface configured for attachment to a pick and place apparatus.

Embodiment 22 is an apparatus comprising: an electrical connector for a memory card, and a cap according to any one of embodiments 15 to 21, the cap configured for engagement with the connector.

Embodiment 23 is the apparatus of embodiment 22 wherein the connector is a connector according to the CFast industry standard.

Whilst there has been described in the foregoing description embodiments of the present invention, it will be understood by those skilled in the technology concerned that many variations in details of design, construction and/or operation may be made without departing from scope as claimed.

### LIST OF REFERENCE NUMERALS

100 apparatus
102 connector
104 cap
106 contacts
108 top pick up surface
109 side pick up surface
110 bottom pick up surface
112 top jaw
114 bottom jaw
116 approximate centre of gravity
118 locating slot
120 main section
122 left finger
124 right finger
126 contact slot
128 end of bottom jaw
130 tongue
132 locating aperture
134 locating flange
136 ejector tab
138 side slots
140 latch
142 slotted tongue
144 tapered flange
146 taper on 144
148 ejector system
150 button
152 pivoted flap
154 top taper
156 bottom taper
158 tongue bumps
160 dual push plate

1. A method comprising:
providing an electrical connector for a memory card, and
placing a pick and place cap onto the connector, including engaging a set of jaws over a row of connector contacts whilst substantially preventing deformation of the contacts.

2. The method of claim 1 further comprising picking up the connector via the cap.

3. The method of claim 1 or 2 further comprising removing the cap from the connector.

4. The method of any one of the preceding claims further comprising locating the cap at a predetermined location.

5. The method of any one of the preceding claims further comprising locking the cap in place on the connector.

6. The method of any of the preceding claims wherein substantially preventing deformation of the contacts comprises preventing contact between the cap and the contacts during placing, removing and during engagement of the cap.

7. An electronic device manufactured according to the method of any one of claims 1 to 6.

8. A pick and place cap for an electrical connector comprising:
a set of jaws to fit over a row of connector contacts, and
a first surface,
wherein the first surface is configured for attachment to a pick and place apparatus.

9. The cap of claim 8 wherein the jaws are configured to lock the cap onto the connector and wherein the jaws are configured to substantially prevent any deformation of the contacts.

10. An apparatus comprising:
an electrical connector for a memory card, and
a cap according to claim 8 or 9, the cap configured for engagement with the connector.
